(19) United States
(12) Patent Application Publication
(10) Pub. No.: US 2023/0146421 A1
(43) Pub. Date: May 11, 2023

(54) Low-Code and No-Code Customization User Interface Components

(71) Applicant: ServiceNow, Inc., Santa Clara, CA (US)

(72) Inventors: Patrick Scott Wilson, New York, NY (US); Kapeel Sharadrao Sable, San Diego, CA (US); Christopher Paul David Johnson, Chicago, IL (US); Bojan Beran, San Diego, CA (US); Carl David Solis, Chicago, IL (US); Benjamin Kresky, San Diego, CA (US); Bhupal Tiduwar Lambodhar, San Diego, CA (US); Kevin Marren, Chicago, IL (US); Anthony Raymond Bullard, Chicago, IL (US)

(21) Appl. No.: 17/521,588

(22) Filed: Nov. 8, 2021

(51) Int. Cl. G06F 8/38; G06F 8/34; G06F 8/41

(52) U.S. Cl. CPC G06F 8/38; G06F 8/34; G06F 8/42

(57) ABSTRACT

Persistent storage may contain a plurality of user interface (UI) component definitions. One or more processors may be configured to: receive, by way of a platform UI builder, selection of a UI component definition from the plurality of UI component definitions; bind, by way of input entered into the platform UI builder, data to the UI component definition, wherein the data is from a data source, and wherein the input is a programmatic statement that references the data source or a set of values that references the data source; generate, by way of the platform UI builder, metadata representing the input; create, by a platform runtime, a UI component that incorporates the data into the UI component definition in accordance with the metadata; generate, by the platform runtime, a graphical user interface including the UI component; and provide, for display on a client device, a representation of the graphical user interface.

### BACKGROUND

Modern computing platforms are often complex systems that obtain data from multiple data sources, possibly both local and remote. Further, these computing platforms may support applications that include various types of graphical user interface (UI) components. The UI components may consume and present visual representations of data from the data sources. However, the data frequently needs to be transformed in some fashion in order to be ingested into the UI components. Conventional computing platforms require that one write software, in a high-level programming language, to bind data sources to components and perform the requisite transformations. As a consequence, the development and customization of UIs can be limited to being carried out only by those who have programming expertise.

### SUMMARY

The embodiments herein provide low-code and no-code techniques for defining bindings between data sources and UI components, as well as how data from the data sources are to be transformed for representation in the UI components. Particularly, structured metadata can be used to define such bindings and transformations, and this structured metadata can be created by way of simple arithmetic/logical/string operations or through graphical menus. This allows an individual who has minimal or no formal training in software development to customize UI components for graphical user interfaces.

Accordingly, a first example embodiment may involve persistent storage containing a plurality of UI component definitions. The first example embodiment may also involve one or more processors configured to: receive, by way of a platform UI builder, selection of a UI component definition from the plurality of UI component definitions; bind, by way of input entered into the platform UI builder, data to the UI component definition, wherein the data is from a data source, and wherein the input is a programmatic statement that references the data source or a set of values that references the data source; generate, by way of the platform UI builder, metadata representing the input; create, by a platform runtime, a custom UI component that incorporates the data into the UI component definition in accordance with the metadata; generate, by the platform runtime, a graphical user interface including the custom UI component; and provide, for display on a client device, a representation of the graphical user interface.

A second example embodiment may involve receiving, by way of a platform UI builder, selection of a UI component definition from a plurality of UI component definitions. The second example embodiment may also involve binding, by way of input entered into the platform UI builder, data to the UI component definition, wherein the data is from a data source, and wherein the input is a programmatic statement that references the data source or a set of values that references the data source. The second example embodiment may also involve generating, by way of the platform UI builder, metadata representing the input. The second example embodiment may also involve creating, by a platform runtime, a custom UI component that incorporates the data into the UI component definition in accordance with the metadata. The second example embodiment may also involve generating, by the platform runtime, a graphical user interface including the custom UI component. The second example embodiment may also involve providing, for display on a client device, a representation of the graphical user interface.

In a third example embodiment, an article of manufacture may include a non-transitory computer-readable medium, having stored thereon program instructions that, upon execution by a computing system, cause the computing system to perform operations in accordance with the first and/or second example embodiment.

In a fourth example embodiment, a computing system may include at least one processor, as well as memory and program instructions. The program instructions may be stored in the memory, and upon execution by the at least one processor, cause the computing system to perform operations in accordance with the first and/or second example embodiment.

In a fifth example embodiment, a system may include various means for carrying out each of the operations of the first and/or second example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5A depicts another communication environment involving a remote network management architecture, in accordance with example embodiments.

FIG. 5B is a flow chart, in accordance with example embodiments.

FIG. 6 depicts a process for developing a UI component, in accordance with example embodiments.

FIG. 7 depicts an architecture for low-code/no-code development of UI components, in accordance with example embodiments.

FIG. 8A depicts a low-code statement and equivalent metadata, in accordance with example embodiments.

FIG. 8B depicts a low-code statement and a tree representation of the equivalent metadata, in accordance with example embodiments.

FIGS. 8C and 8D depict dynamic UI components that can be generated from interpreting the metadata with associated application state, in accordance with example embodiments.

FIG. 9 depicts a no-code specification and equivalent metadata, in accordance with example embodiments.

FIG. 10 depicts a graphical user interface for a platform UI builder, in accordance with example embodiments.

FIG. 11 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. INTRODUCTION

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM) and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) is introduced, to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure.

The aPaaS system may support standardized application components, such as a standardized set of widgets for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional MVC application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HTML and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### II. EXAMPLE COMPUTING DEVICES AND CLOUD-BASED COMPUTING ENVIRONMENTS

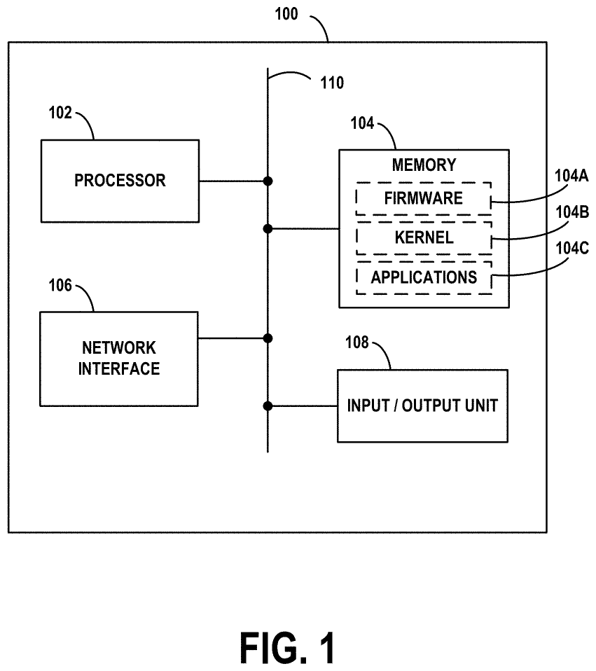

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling, and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed to support an aPaaS architecture. The exact physical location, connectivity, and configuration of these computing devices may be unknown and/or unimportant to client devices. Accordingly, the computing devices may be referred to as “cloud-based” devices that may be housed at various remote data center locations.

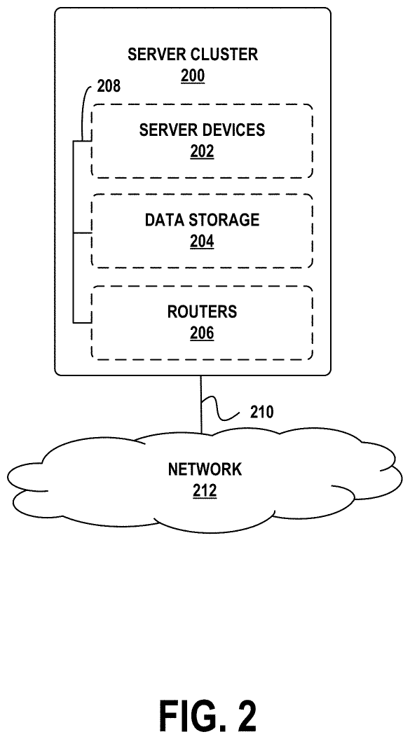

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as the hypertext markup language (HTML), the extensible markup language (XML), or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### III. EXAMPLE REMOTE NETWORK MANAGEMENT ARCHITECTURE

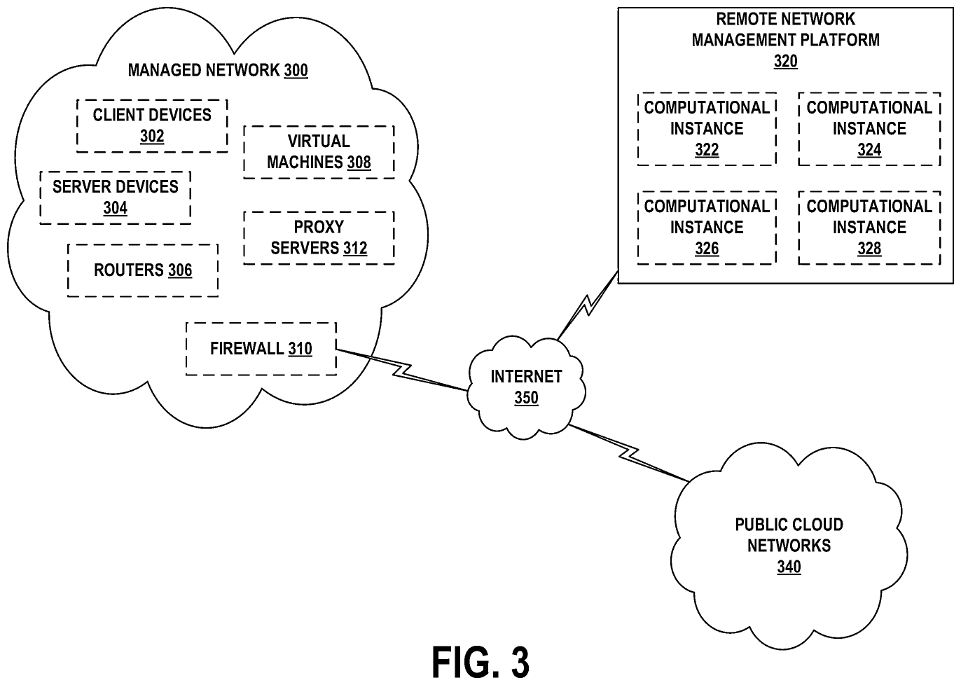

FIG. 3 depicts a remote network management architecture, in accordance with example embodiments. This architecture includes three main components—managed network 300, remote network management platform 320, and public cloud networks 340—all connected by way of Internet 350.

A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components. Possibly with the assistance of proxy servers 312, remote network management platform 320 may also be able to discover and manage aspects of public cloud networks 340 that are used by managed network 300.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may affect all customers' data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include AMAZON WEB SERVICES® and MICROSOFT® AZURE®. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

D. Communication Support and Other Operations

Internet 350 may represent a portion of the global Internet. However, Internet 350 may alternatively represent a different type of network, such as a private wide-area or local-area packet-switched network.

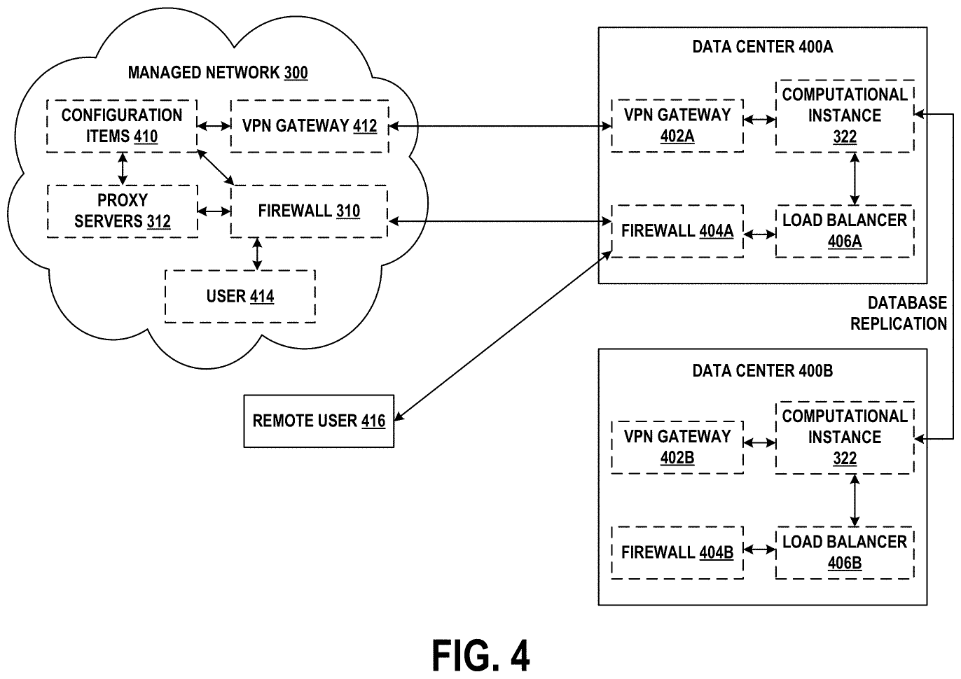

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any applications or services executing thereon, as well as relationships between devices, applications, and services. Thus, the term “configuration items” may be shorthand for any physical or virtual device, or any application or service remotely discoverable or managed by computational instance 322, or relationships between discovered devices, applications, and services. Configuration items may be represented in a configuration management database (CMDB) of computational instance 322.

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively).

### IV. EXAMPLE DEVICE, APPLICATION, AND SERVICE DISCOVERY

In order for remote network management platform 320 to administer the devices, applications, and services of managed network 300, remote network management platform 320 may first determine what devices are present in managed network 300, the configurations and operational statuses of these devices, and the applications and services provided by the devices, as well as the relationships between discovered devices, applications, and services. As noted above, each device, application, service, and relationship may be referred to as a configuration item. The process of defining configuration items within managed network 300 is referred to as discovery, and may be facilitated at least in part by proxy servers 312.

For purposes of the embodiments herein, an “application” may refer to one or more processes, threads, programs, client modules, server modules, or any other software that executes on a device or group of devices. A “service” may refer to a high-level capability provided by multiple applications executing on one or more devices working in conjunction with one another. For example, a high-level web service may involve multiple web application server threads executing on one device and accessing information from a database application that executes on another device.

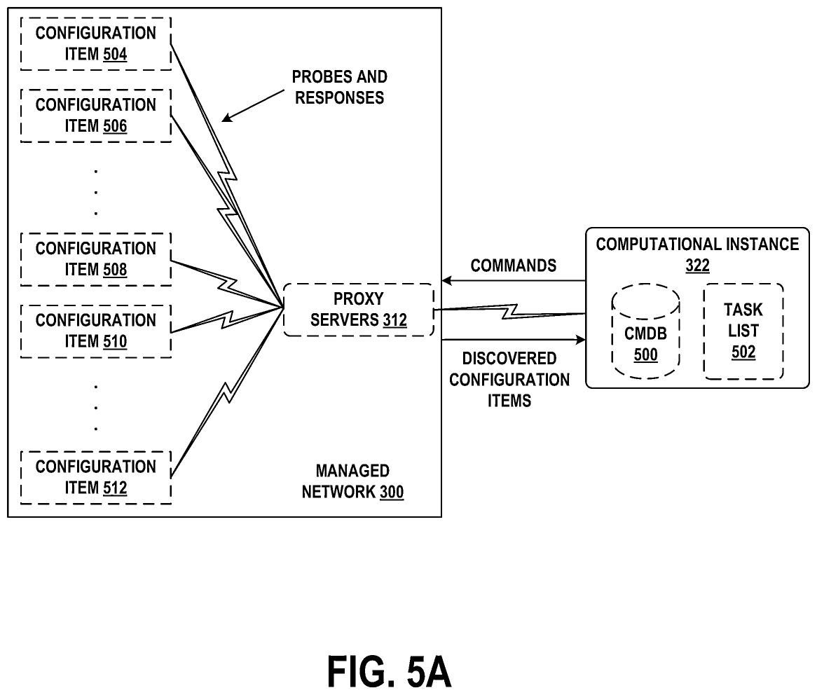

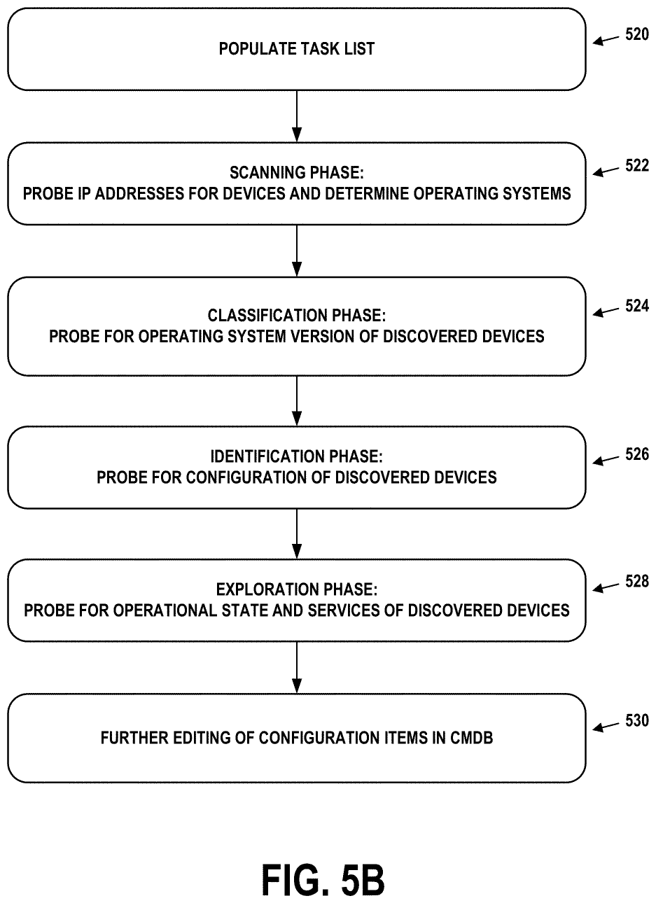

FIG. 5A provides a logical depiction of how configuration items can be discovered, as well as how information related to discovered configuration items can be stored. For sake of simplicity, remote network management platform 320, public cloud networks 340, and Internet 350 are not shown.

In FIG. 5A, CMDB 500 and task list 502 are stored within computational instance 322. Computational instance 322 may transmit discovery commands to proxy servers 312. In response, proxy servers 312 may transmit probes to various devices, applications, and services in managed network 300. These devices, applications, and services may transmit responses to proxy servers 312, and proxy servers 312 may then provide information regarding discovered configuration items to CMDB 500 for storage therein. Configuration items stored in CMDB 500 represent the environment of managed network 300.

Task list 502 represents a list of activities that proxy servers 312 are to perform on behalf of computational instance 322. As discovery takes place, task list 502 is populated. Proxy servers 312 repeatedly query task list 502, obtain the next task therein, and perform this task until task list 502 is empty or another stopping condition has been reached.

To facilitate discovery, proxy servers 312 may be configured with information regarding one or more subnets in managed network 300 that are reachable by way of proxy servers 312. For instance, proxy servers 312 may be given the IP address range 192.168.0/24 as a subnet. Then, computational instance 322 may store this information in CMDB 500 and place tasks in task list 502 for discovery of devices at each of these addresses.

FIG. 5A also depicts devices, applications, and services in managed network 300 as configuration items 504, 506, 508, 510, and 512. As noted above, these configuration items represent a set of physical and/or virtual devices (e.g., client devices, server devices, routers, or virtual machines), applications executing thereon (e.g., web servers, email servers, databases, or storage arrays), relationships therebetween, as well as services that involve multiple individual configuration items.

Placing the tasks in task list 502 may trigger or otherwise cause proxy servers 312 to begin discovery. Alternatively or additionally, discovery may be manually triggered or automatically triggered based on triggering events (e.g., discovery may automatically begin once per day at a particular time).

In general, discovery may proceed in four logical phases: scanning, classification, identification, and exploration. Each phase of discovery involves various types of probe messages being transmitted by proxy servers 312 to one or more devices in managed network 300. The responses to these probes may be received and processed by proxy servers 312, and representations thereof may be transmitted to CMDB 500. Thus, each phase can result in more configuration items being discovered and stored in CMDB 500.

In the scanning phase, proxy servers 312 may probe each IP address in the specified range of IP addresses for open Transmission Control Protocol (TCP) and/or User Datagram Protocol (UDP) ports to determine the general type of device. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist. Once the presence of a device at a particular IP address and its open ports have been discovered, these configuration items are saved in CMDB 500.

In the classification phase, proxy servers 312 may further probe each discovered device to determine the version of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 2012, as a set of WINDOWS®-2012-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (applications), and so on. Once more, the discovered information may be stored as one or more configuration items in CMDB 500.

Running discovery on a network device, such as a router, may utilize SNMP. Instead of or in addition to determining a list of running processes or other application-related information, discovery may determine additional subnets known to the router and the operational state of the router's network interfaces (e.g., active, inactive, queue length, number of packets dropped, etc.). The IP addresses of the additional subnets may be candidates for further discovery procedures. Thus, discovery may progress iteratively or recursively.

Once discovery completes, a snapshot representation of each discovered device, application, and service is available in CMDB 500. For example, after discovery, operating system version, hardware configuration, and network configuration details for client devices, server devices, and routers in managed network 300, as well as applications executing thereon, may be stored. This collected information may be presented to a user in various ways to allow the user to view the hardware composition and operational status of devices, as well as the characteristics of services that span multiple devices and applications.

Furthermore, CMDB 500 may include entries regarding dependencies and relationships between configuration items. More specifically, an application that is executing on a particular server device, as well as the services that rely on this application, may be represented as such in CMDB 500. For example, suppose that a database application is executing on a server device, and that this database application is used by a new employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular router fails.

In general, dependencies and relationships between configuration items may be displayed on a web-based interface and represented in a hierarchical fashion. Thus, adding, changing, or removing such dependencies and relationships may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

In order for discovery to take place in the manner described above, proxy servers 312, CMDB 500, and/or one or more credential stores may be configured with credentials for one or more of the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

The discovery process is depicted as a flow chart in FIG. 5B. At block 520, the task list in the computational instance is populated, for instance, with a range of IP addresses. At block 522, the scanning phase takes place. Thus, the proxy servers probe the IP addresses for devices using these IP addresses, and attempt to determine the operating systems that are executing on these devices. At block 524, the classification phase takes place. The proxy servers attempt to determine the operating system version of the discovered devices. At block 526, the identification phase takes place. The proxy servers attempt to determine the hardware and/or software configuration of the discovered devices. At block 528, the exploration phase takes place. The proxy servers attempt to determine the operational state and applications executing on the discovered devices. At block 530, further editing of the configuration items representing the discovered devices and applications may take place. This editing may be automated and/or manual in nature.

The blocks represented in FIG. 5B are examples. Discovery may be a highly configurable procedure that can have more or fewer phases, and the operations of each phase may vary. In some cases, one or more phases may be customized, or may otherwise deviate from the exemplary descriptions above.

In this manner, a remote network management platform may discover and inventory the hardware, software, and services deployed on and provided by the managed network. As noted above, this data may be stored in a CMDB of the associated computational instance as configuration items. For example, individual hardware components (e.g., computing devices, virtual servers, databases, routers, etc.) may be represented as hardware configuration items, while the applications installed and/or executing thereon may be represented as software configuration items.

The relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

The relationship between a service and one or more software configuration items may also take various forms. As an example, a web service may include a web server software configuration item and a database application software configuration item, each installed on different hardware configuration items. The web service may have a “depends on” relationship with both of these software configuration items, while the software configuration items have a “used by” reciprocal relationship with the web service. Services might not be able to be fully determined by discovery procedures, and instead may rely on service mapping (e.g., probing configuration files and/or carrying out network traffic analysis to determine service level relationships between configuration items) and possibly some extent of manual configuration.

Regardless of how relationship information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

### V. UI COMPONENTS AND CONFIGURATION THEREOF

Modern graphical user interfaces may be comprised of a number of UI components that are arranged in a particular fashion. These UI components could be, but are not limited to, avatars, badges, buttons, calendars, cards, checkboxes, containers, forms, icons, images, lists, menus, messages, notifications, pickers, progress bars, sidebars, sliders, tabs, text boxes, toggles, and so on. In order to make graphical user interfaces interactive, each UI component can be programmed with code that specifies one or more data sources as well as transformations to be performed on data from these data sources that specify how the data is to be displayed within the component.

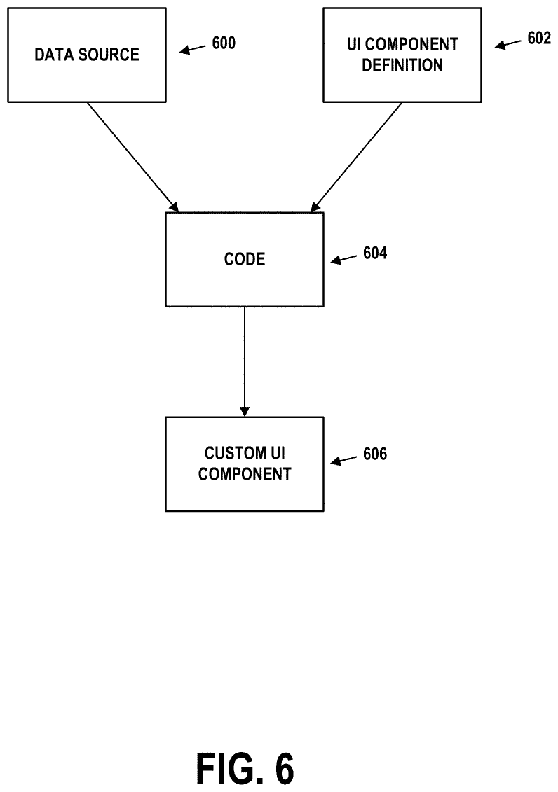

FIG. 6 depicts an example. Data source 600 provides data to populate a UI component. Data source 600 could be a file, a database, a database table, an application programming interface (API) such as a representational state transfer (REST) interface, or state stored within an application among other possibilities.

UI component definition 602 defines the structure and static aspects of the appearance of a UI component, but might not specify the content of any dynamic aspects of the UI component. For instance, UI component definition 602 may define one or more text boxes without specifying the content of these text boxes or what events might trigger modification of such content.

Code 604 may be program logic written in a high-level programming language (e.g., JAVA®, JAVASCRIPT®, etc.). Code 604 may be attached to or otherwise associated with UI component definition 602 in order to control its dynamic aspects. Thus, code 604 may specify data source 600 and include one or more transformations to apply to data from data source 600 when populating this data in UI component definition 602. These transformations could include arithmetic operations, logical operations, string operations, and so on.

The result of applying code 604 to UI component definition 602 and incorporating data from data source 600 is custom UI component 606. Custom UI component 606 may display the data from data source 600 as transformed by code 604 and within the framework of UI component definition 602. Further, custom UI component 606 can be incorporated into a graphical user interface possibly containing other UI components as well.

Development of code 604 requires a software engineer, often someone with years of software development experience. As a consequence, the number of individuals who can develop graphical user interfaces on computing platforms (e.g., remote network management platform 320) is limited to those with the appropriate skills. Furthermore, the writing of code 604 can be a complex and error-prone process, often requiring cycles of development, testing, and debugging.

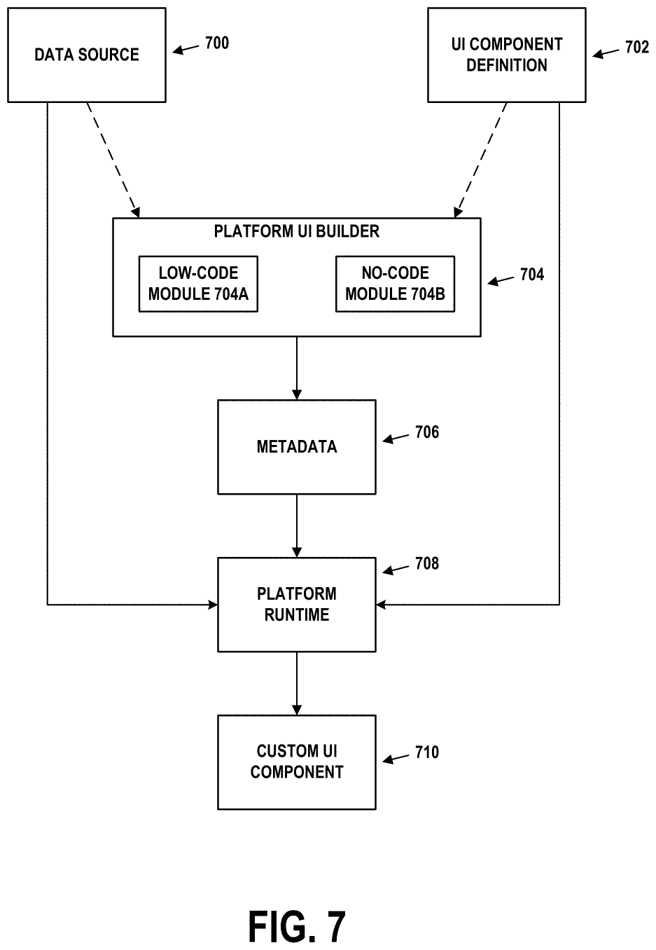

In contrast, FIG. 7 depicts an architecture that provides for low-code or no-code definition of bindings between data sources and UI components, as well as transformations to be applied to data from the data sources. A binding may indicate that certain units of data from a data source should be used to populate a particular aspect of a UI component. A transformation may define how these units of data are to be manipulated for display in the UI component.

In FIG. 7, data source 700 and UI component definition 702 serve as input to platform UI builder 704, which in turn produces metadata that can be used to customize UI component definition 702. As noted, data source 700 may be a file, a database, a database table, an API, state stored within an application, or some other supply of data. Like UI component definition 602, UI component definition 702 defines the structure and static aspects of the appearance of a UI component, but may leave placeholders for certain aspects of its appearance that are dynamic.

Platform UI builder 704 may be a software application that allows definition of bindings between data source 700 and UI component definition 702, as well as any transformations to be made on the data from data source 700 that is integrated with UI component definition 702. Such a binding can be made in a low-code fashion, such as by way of an arithmetic or logical expression, or in a no-code fashion, by way of options chosen from or specified in a menu. Particularly, low-code module 704A represents the ability of platform UI builder 704 to facilitate low-code bindings and transformations, and no-code module 704B represents the ability of platform UI builder 704 to facilitate no-code bindings and transformations.

In some embodiments, platform UI builder 704 may be a graphical user interface. However, other possibilities exist. The dashed arrows between data source 700 and platform UI builder 704, as well as between UI component definition 702 and platform UI builder 704, indicate that platform UI builder 704 may reference or otherwise rely on data source 700 and UI component definition 702 from a development perspective.

Regardless, platform UI builder 704 may generate metadata 706. Metadata 706 may be a specification of the binding and the transformations. Platform UI builder 704 may generate metadata from low-code module 704A and/or no-code module 704B. In various embodiments, metadata 706 may take the form of structured data, such as XML or JavaScript Object Notation (JSON). Nevertheless, other alphanumeric or binary formats could be used. Metadata 706 may be stored in one or more files on the same platform as platform UI builder 704 or may be transmitted to a different platform.

Platform runtime 708 may be a software application that uses data from data source 700, UI component definition 702, and metadata 706 to generate custom UI component 710. For example, platform runtime 708 may read metadata 706, determine that it contains bindings and transformations relating to data source 700 and UI component definition 702, and then access data source 700 and use UI component definition 702 as needed. This may involve filling in the dynamic aspects of UI component definition 702 with data from data source 700 that has been transformed in accordance with any specified transformations. Platform runtime 708 may be a middleware layer or library to which applications executing on a platform have access, and that facilitates the display of custom graphical user interfaces.

Custom UI component 710 can then be integrated into a larger graphical user interface, for instance with one or more additional UI components. Alternatively or additionally, custom UI component 710 could be placed in a library of customized and/or standard UI components that can be used in one or more of these larger graphical user interfaces.

In some embodiments, platform UI builder 704 may incorporate data from multiple data sources and/or multiple UI component definitions in order to generate metadata 706. Further, platform UI builder 704 could be on the same or a different platform as that of platform runtime 708.

Notably, platform UI builder 704 may facilitate design of custom UI components and their integration into graphical user interfaces, while platform runtime 708 may facilitate the execution and use of these custom UI components and graphical user interfaces by an end user. Thus, the architecture herein supports separate logical design time and run time operations, which may be carried out at different points in time and by different users.

A. Low-Code Metadata Generation

As noted, low-code module 704A may generate metadata 706 using arithmetic, logical, and/or string operations as just some possibilities. Doing so may involve writing of simple declarative, conditional, and/or control-flow statements formatted not unlike a high-level programming language. In some cases, a limited set of predefined keywords may be used in these statements.

Further, such a statement (or a sequence of statements) may be in the form of a context-free grammar. Thus, it may be comprised of a set of terminal symbols (e.g., keywords), as well as a set of non-terminal symbols (e.g., variables) that are placeholders for patterns of other terminal and non-terminal symbols. Each context-free grammar also includes a set of production rules that define (typically in a recursive fashion) how terminal symbols are generated from non-terminal symbols. Context free grammars have a number of advantageous practical properties, such as the ability to be parsed unambiguously, and transform statements consistent with the context free grammar into other representations in a one-to-one fashion.

An illustrative example follows. Suppose that a text box UI component allows the text to be displayed therein to be customized. Thus, a UI component definition for this UI component may specify the text box, such as its dimensions, its border, and the font, size, and color of its text. But the UI component definition may indicate that the text content of the text box is configurable.

Suppose further that a possible data source is application state, notably state of the application that incorporates the text box into its graphical user interface. This state is accessed by way of a “state” object with a method isLoggedIn that returns a Boolean value indicating whether a user is logged in to the application, and another method myName that returns a string specifying a logged-in user's name.

In the application, it is desirable for the text box to greet the user by displaying the string “Hello” if the user is not logged in. But if the user is logged in, it is desirable for the text box to greet the user by name—for example, is the user's name is “Alice”, the text box would display “Hello Alice”. The following low-code statement achieves this goal.

IF(@state.isLoggedIn, CONCAT(“Hello”, @state.myName), “Hello”)

Notably, this IF statement evaluates the condition represented by the Boolean return value of method state.isLoggedIn. If the return value of the condition is true (and thus the user is logged in), the embedded string concatenation statement CONCAT produces a string consisting of “Hello” followed by the user's name as obtained from the string return value of method state.myName. If the return value of the condition is false (and thus the user is not logged in), the string literal “Hello” is provided.

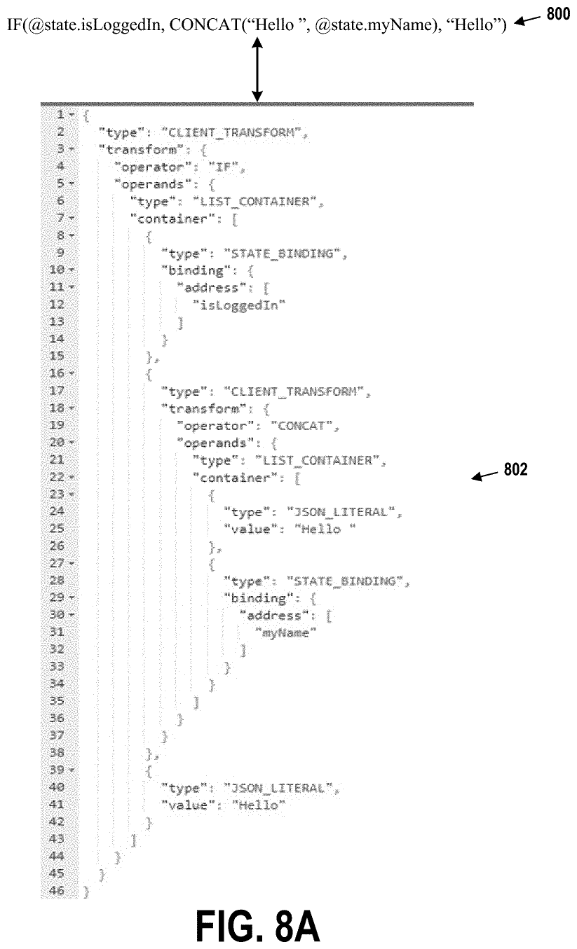

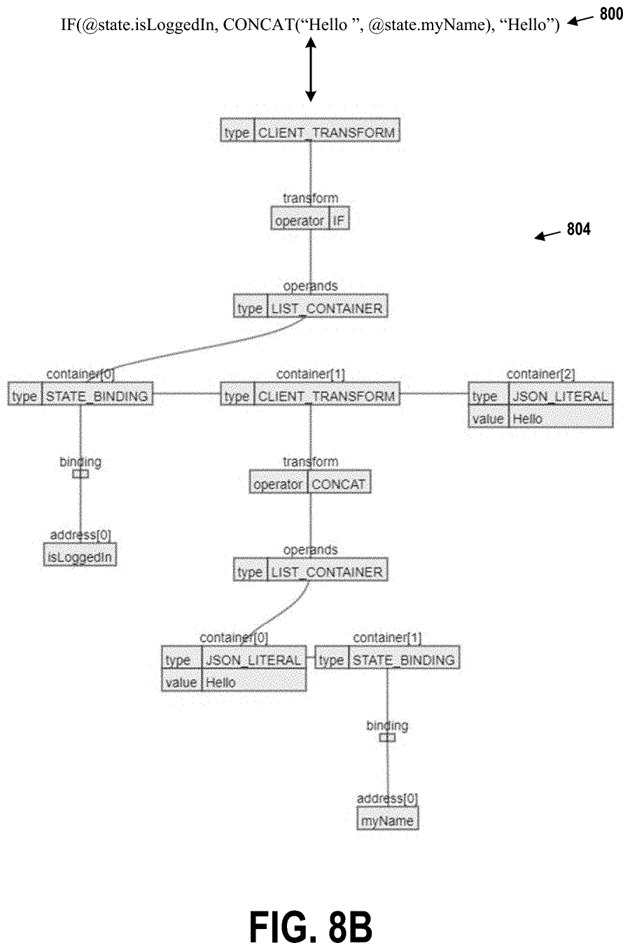

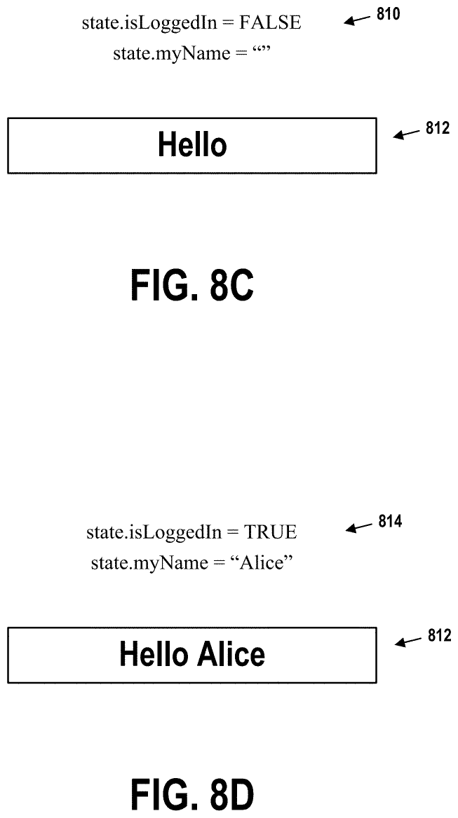

Low-code module 704A can use this statement to generate a metadata representation that can be supplied to platform runtime 708. While many possible representations could be used, an illustrative example is provided in FIGS. 8A and 8B.

FIG. 8A depicts translation between low-code statement 800 (which is the IF statement given above) and JSON file 802. The strings used in JSON file 802 are chosen for purposes of illustration and could have different values. In short, low-code module 704A uses a compiler-like function to translate low-code statement 800 into the syntax tree of JSON file 802. To illuminate how low-code module 704A performs this “compilation”, FIG. 8B depicts translation from low-code statement 800 to JSON tree 804. JSON tree 804 is a visual representation of JSON file 802 is which it is easier to determine how the parts of low-code statement 800 are represented as JSON elements.

In both figures, the IF and CONCAT statements are represented as JSON elements. The IF statement takes three type parameters (a STATE_BINDING to the method state.isLoggedIn, the CONCAT statement, and the JSON_LITERAL “Hello”), all stored in a container. The CONCAT statement takes two parameters (the JSON_LITERAL “Hello”, and a STATE_BINDING to the method state.myName), both stored in a container.

In JSON file 802 and JSON tree 804, the method state.isLoggedIn and the method state.myName are both of type “STATE_BINDING”. Other types may be used to indicate bindings to different data sources, such as data from a file, database table, or REST API.

The arrow between low-code statement 800 and JSON file 802 is bidirectional to indicate that there is a one-to-one mapping between these pieces of information. Thus, low-code statement 800 can be “compiled” into JSON file 802, and JSON file 802 can be “reverse-compiled” into low-code statement 800. Likewise, the arrow between low-code statement 800 and JSON tree 804 is also bidirectional.

Such compilation can be based on use of a context-free grammar parser on low-code statements. This results in the application of production rules to low-code statements in order to generate a sequence of terminal symbols. Here, the terminal symbols are the elements of JSON file 802, or these elements can be unambiguously generated from a sequence of intermediate terminal symbols.

FIGS. 8C and 8D depict application states and the content of an associated custom UI component that displays information based on the application states. The custom UI component could be produced dynamically by platform runtime 708 from JSON file 802 (i.e., JSON file is at least part of metadata 706).

FIG. 8C includes state 810 and text box 812. Text box 812 is a UI component that is populated based on JSON file 802. Given state 810, the method state.isLoggedIn would return FALSE and the method state.myName would return an empty string. Thus, in this scenario, text box 812 displays the string “Hello”.

FIG. 8D includes state 814 and text box 812. Given state 814, the method state.isLoggedIn would return TRUE and the method state.myName would return the string “Alice”. Thus, in this scenario, text box 812 displays the string “Hello Alice”.

For instance, platform runtime 708 could read JSON file 802 to identify data from data source 700, obtain this data, transform it in accordance with operations encoded in JSON file 802, and place it in the appropriate locations of UI component definition 702. The result would be custom UI component 710. In some cases, a separate JSON file may exist for each dynamic aspect of UI component definition 702.

In this manner, the string displayed in text box 812 is dynamically determined based on application state (e.g., state stored in a server device or provided by a client device). This means that as the state changes, the displayed string may also change accordingly. Previously, such a dynamic feature would require a significantly amount of coding in a high-level language, but in these embodiments, a single low-code statement is sufficient.

A goal of such a low-code implementation is to facilitate the development and integration of custom UI components in a manner that is no more difficult than programming a spreadsheet application, for example. Thus, individuals with minimal training and experience in programming can incorporate custom UI components into a graphical user interface.

B. No-Code Metadata Generation

Nonetheless, it may be possible to further simplify the use of custom UI components. No-code development environments allow individuals to program by way of selecting options from a graphical user interface. While the scope of no-code development can be narrower than low-code development (in that some functionality that is available by way of low-code development might not be available by way of no-code development), no-code development is simpler and thus useable by a wider audience. No-code module 704B may display a graphical user interface through which certain options relating to data sources and UI component definitions can be selected, so that specific data from a data source may be used in a custom UI component.

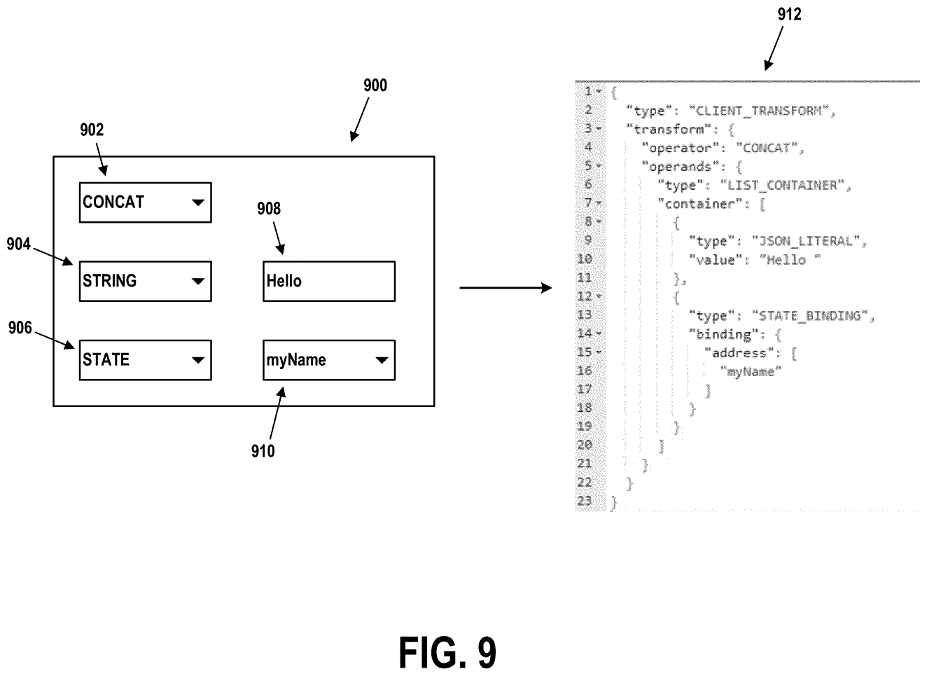

FIG. 9 provides a simple example of no-code graphical user interface 900 that no-code module 704B can use to create JSON file 912. Notably, JSON file 912 is a portion of JSON file 802.

No-code graphical user interface 900 allows the specification of functionality that is equivalent to the CONCAT statement discussed above. For example, dropdown menu 902 may contain a selectable list of options, and a user may select the CONCAT option from this list. Doing so may cause dropdown menu 904 and dropdown menu 906 to appear. Each of these represents one of the two arguments that will be provided to the CONCAT statement.

Dropdown menu 904 may contain a selectable list of data sources, and a user may select the STRING option from this list in order to enter a free-form string. Doing so may cause text box 908 to appear, and the user may enter the string “Hello” into this text box.

Dropdown menu 906 may also contain a selectable list of data sources, and a user may select the STATE option from this list in order to specify application state. Doing so may cause dropdown menu 910 to appear. Dropdown menu 910 may contain a selectable list of methods supported by the application state object. The user may select the myName method from this dropdown menu.

With these selections in place on no-code graphical user interface 900, no-code module 704B could be triggered to create JSON file 912. Notably, the arrow from no-code graphical user interface 900 to JSON file 912 is unidirectional indicating that JSON file 912 can be unambiguously generated from no-code graphical user interface 900 as shown, but there are many possible no-code graphical user interfaces that also could be used for the same purpose.

The generation of JSON file 912 from no-code graphical user interface 900 need not rely on context-free grammars. Instead, the hierarchy of blocks and elements of JSON file 912 can be generated directly from what is specified in no-code graphical user interface 900. To that point, each operation specified in no-code graphical user interface 900 is associated with a number of operands also specified in no-code graphical user interface 900. The selected values from each can be used as the basis of JSON file 912. For example, the selection of dropdown menu 902 determines the “operator” element in JSON file 912, and the selections of dropdown menu 904, dropdown menu 906, text box 908, and dropdown menu 910 determine the “operands” element in JSON file 912.

The example of FIG. 9 is simple for purposes of illustration. More involved graphical user interfaces could be used to generate more complex and detailed JSON files.

### VI. PLATFORM UI BUILDER

As noted, platform UI builder 704 may facilitate both low-code and no-code generation of metadata. In some embodiments, platform UI builder 704 may do so in a visual fashion, by way of its own graphical user interface.

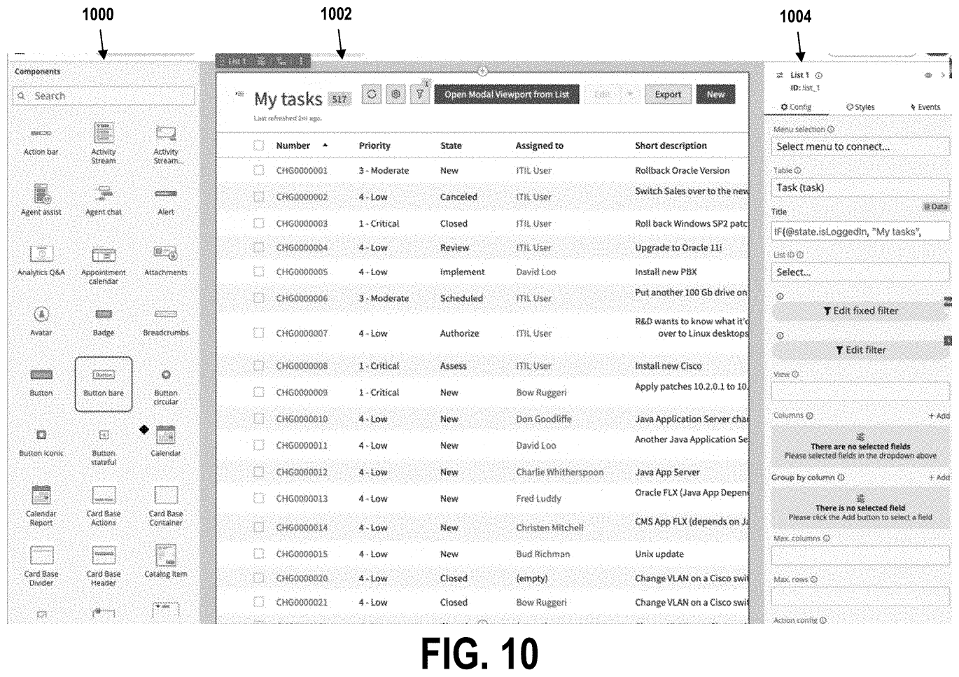

FIG. 10 provides an example of such a graphical user interface. Particularly, the graphical user interface includes three sections. Section 1000 allows selection of UI components, section 1002 displays the current arrangement of selected UI components in a workspace, and section 1004 allows configuration of these UI components in a low-code or no-code fashion. Advantageously, this graphical user interface updates the display of the UI components in real time based on changes made to their configurations. Thus, the user is presented with an accurate representation of how these UI components would actually appear when integrated into an application.

Section 1000 may allow the user to select and drag representations of UI component definitions to section 1002. As noted above, a wide variety of UI component definitions may be available, including many not shown in FIG. 10. Each of these UI component definitions may be an off-the-shelf definition or may be customized in some fashion.

Section 1002 may allow the user to arrange the selected UI component definitions into an interface layout. Further, section 1002 may display content for each as configured by way of section 1004. Thus, for example, an interface layout in section 1002 may consist of a text box UI component definition, a list UI component definition, and two button UI component definitions. Section 1002 may allow the user to drag and drop these UI component definitions into the desired locations relative to one another. For purposes of simplicity, FIG. 10 section 1002 just shows a list UI component that is consistent with the list UI component definition.

As noted, section 1004 allows each of the UI component definitions in section 1002 to be configured in a low-code or no-code fashion. For example, section 1004 contains a dropdown menu labeled “Table” from which a database table to populate the list shown in section 1002 can be selected. Section 1004 also contains a text box labeled “Title”. This text box contains a low-code statement being used to dynamically control the content displayed at the top left of the list shown in section 1002.

Additionally, if the user actuates the “edit filter” button in section 1004, a further window may pop up (not shown) with a graphical menu that allows the user to define a filter using dropdown menu, text boxes, and Boolean conditions for example. In this manner, low-code and no-code development can both be used with the same UI component definition.

Thus, the graphical user interface of platform UI builder 704 allows binding a UI component definition to a data source such that data from the data source is used to populate parts of the resulting UI component. This can be done without requiring any high-level programming (e.g., in JAVA® or JAVASCRIPT®), thereby facilitating development by a much broader set of users.

### VII. PLATFORM RUNTIME

Platform runtime 708 may be an interpreter or other type of program that takes as input one or more UI component definitions as well as associated metadata generated by platform UI builder 704. When the resulting custom UI components are incorporated into a graphical user interface, platform runtime 708 may populate these custom UI components with data obtained from data sources specified in the metadata and possibly transformed as specified in the metadata. Further, when a data source is updated (e.g., an application state change) or a custom UI component is modified by an end user (e.g., by selection of an option), platform runtime 708 may update the custom UI component as displayed to be consistent with the update and/or the modification. In this manner, platform runtime 708 can be thought of as “executing” the metadata each time the custom UI component needs to be updated.

### VIII. EXAMPLE OPERATIONS

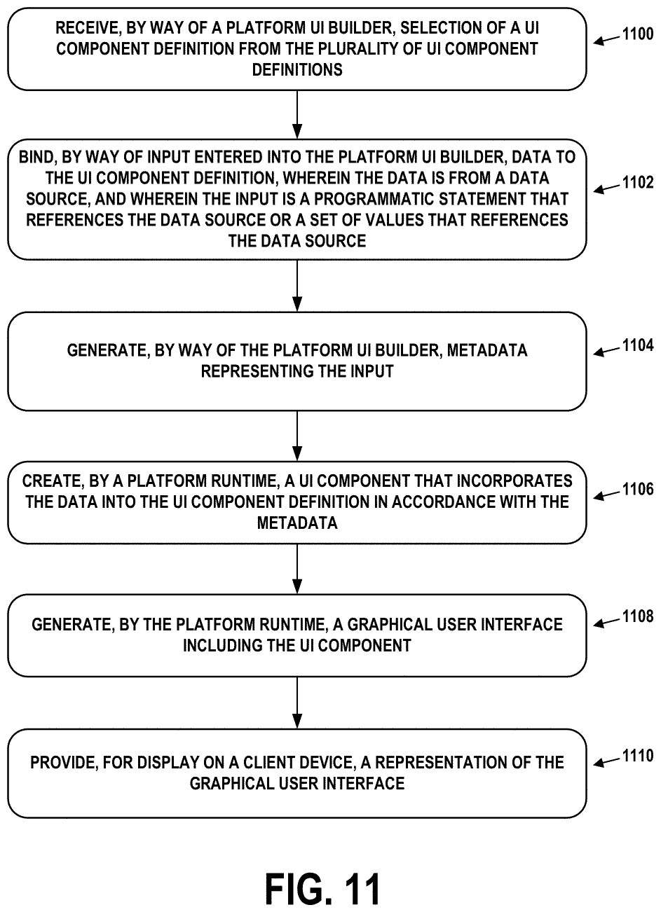

FIG. 11 is a flow chart illustrating an example embodiment. The process illustrated by FIG. 11 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 11 may be simplified by the removal of any one or more of the features shown therein. Further, these embodiments may be combined with features, aspects, and/or implementations of any of the previous figures or otherwise described herein.

Block 1100 may involve receiving, by way of a platform UI builder, selection of a UI component definition from a plurality of UI component definitions.

Block 1102 may involve binding, by way of input entered into the platform UI builder, data to the UI component definition, wherein the data is from a data source, and wherein the input is a programmatic statement that references the data source or a set of values that references the data source. The programmatic statement may be a low-code expression rather than in a high-level programming language. The set of values may be received by way of a no-code interface.

Block 1104 may involve generating, by way of the platform UI builder, metadata representing the input.

Block 1106 may involve creating, by a platform runtime, a custom UI component that incorporates the data into the UI component definition in accordance with the metadata.

Block 1108 may involve generating, by the platform runtime, a graphical user interface including the custom UI component.

Block 1110 may involve providing, for display on a client device, a representation of the graphical user interface.

Notably, blocks 1100, 1102, and 1104 may be performed at design time, while blocks 1106, 1108, and 1110 may be performed at run time. There may be a gap of time between design time and run time, and different users may be involved in each phase (e.g., designers and end users, respectively).

Some embodiments may further involve determining that the data has changed; possibly in response to determining that the data has changed, updating the custom UI component to incorporate the data as changed into the UI component definition in accordance with the metadata; and providing, for display on the client device, a further representation of the graphical user interface with the custom UI component as updated. This determining, updating and displaying may occur without modifications being made to the metadata.

In some embodiments, the input is the programmatic statement, wherein the programmatic statement conforms to a context-free grammar, and wherein generating the metadata representing the input comprises compiling the programmatic statement into a hierarchical structure of elements in the metadata.

In some embodiments, the input is the set of values, wherein the set of values were selected or entered into a menu-based interface.

In some embodiments, the input is the set of values, wherein generating the metadata representing the input comprises transforming the set of values into a hierarchical structure of elements in the metadata.

In some embodiments, the input specifies the data source and transformations to be made to the data.

In some embodiments, the UI component definition includes static aspects and dynamic aspects, wherein the UI component definition specifies the static aspects and placeholders for the dynamic aspects, and wherein the data provides parameters for the placeholders.

In some embodiments, the data source is a file, a database table, an application programming interface, or an application state.

In some embodiments, the UI component definition specifies a button, card, checkbox, container, form, list, menu, or text box.

In some embodiments, the metadata is formatted in accordance with XML, or JSON.

In some embodiments, the platform UI builder displays an interface with a component selector section, a component display workspace section, and a component configuration section, wherein the component selector section displays the plurality of UI component definitions and allows selection of the UI component definition, wherein the component display workspace section displays a live representation of the custom UI component populated with the data, and wherein the component configuration section allows entry of the input. In some embodiments, entry of the input causes regeneration of the live representation of the custom UI component populated with the data.

### IX. CLOSING

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid-state drive, or another storage medium.

The computer readable medium can also include non-transitory computer readable media such as non-transitory computer readable media that store data for short periods of time like register memory and processor cache. The non-transitory computer readable media can further include non-transitory computer readable media that store program code and/or data for longer periods of time. Thus, the non-transitory computer readable media may include secondary or persistent long-term storage, like ROM, optical or magnetic disks, solid-state drives, or compact disc read only memory (CD-ROM), for example. The non-transitory computer readable media can also be any other volatile or non-volatile storage systems. A non-transitory computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

1. A system comprising:
persistent storage containing a plurality of user interface (UI) component definitions; and
one or more processors configured to:
receive, by way of a platform UI builder, an input corresponding to selection of a UI component definition from the plurality of UI component definitions;
bind, according to a low-code module implemented as part of the UI builder, data specified as part of the input entered into the platform UI builder to the UI component definition, wherein the low-code module utilizes the data to populate the UI component definition, and wherein the data is from a data source, and wherein the input includes a programmatic statement that references the data source or a set of values that references the data source;
generate, by way of the platform UI builder, metadata representing the input and the populated UI component definition;
create, by a platform runtime, a custom UI component according to the metadata including the data populating the UI component definition;
generate, by the platform runtime, a graphical user interface including the custom UI component; and
provide, for display on a client device, a representation of the graphical user interface.

2. The system of claim 1, wherein the one or more processors are further configured to:
determine that the data has changed;
in response to determining that the data has changed, update the custom UI component to incorporate the data as changed into the UI component definition in accordance with the metadata; and
provide, for display on the client device, a further representation of the graphical user interface with the custom UI component as updated.

3. The system of claim 1, wherein the input is the programmatic statement, wherein the programmatic statement conforms to a context-free grammar, and wherein generating the metadata representing the input comprises compiling the programmatic statement into a hierarchical structure of elements in the metadata.

4. The system of claim 1, wherein the input is the set of values, and wherein the set of values were selected or entered into a menu-based interface.

5. The system of claim 1, wherein the input is the set of values, and wherein generating the metadata representing the input comprises transforming the set of values into a hierarchical structure of elements in the metadata.

6. The system of claim 1, wherein the input specifies the data source and transformations to be made to the data.

7. The system of claim 1, wherein the UI component definition includes static aspects and dynamic aspects, wherein the UI component definition specifies the static aspects and placeholders for the dynamic aspects, and wherein the data provides parameters for the placeholders.

8. The system of claim 1, wherein the data source is a file, a database table, an application programming interface, or an application state.

9. The system of claim 1, wherein the UI component definition specifies a button, card, checkbox, container, form, list, menu, or text box.

10. The system of claim 1, wherein the metadata is formatted in accordance with eXtensible Markup Language (XML) or JavaScript Object Notation (JSON).

11. The system of claim 1, wherein the platform UI builder displays an interface with a component selector section, a component display workspace section, and a component configuration section, wherein the component selector section displays the plurality of UI component definitions and allows selection of the UI component definition, wherein the component display workspace section displays a live representation of the custom UI component populated with the data, and wherein the component configuration section allows entry of the input.

12. The system of claim 11, wherein entry of the input causes regeneration of the live representation of the custom UI component populated with the data.

13. A computer-implemented method comprising:
receiving, by way of a platform UI builder, an input corresponding to selection of a UI component definition from a plurality of UI component definitions;
binding, according to a low-code module implemented as part of the UI builder, data specified as part of the input entered into the platform UI builder to the UI component definition, wherein the low-code module utilizes the data to populate the UI component definition, and wherein the data is from a data source, and wherein the input includes a programmatic statement that references the data source or a set of values that references the data source;
generating, by way of the platform UI builder, metadata representing the input and the populated UI component definition;
creating, by a platform runtime, a custom UI component according to the metadata including the data populating the UI component definition;
generating, by the platform runtime, a graphical user interface including the custom UI component; and
providing, for display on a client device, a representation of the graphical user interface.

14. The computer-implemented method of claim 13, further comprising:
determining that the data has changed;
in response to determining that the data has changed, updating the custom UI component to incorporate the data as changed into the UI component definition in accordance with the metadata; and
providing, for display on the client device, a further representation of the graphical user interface with the custom UI component as updated.

15. The computer-implemented method of claim 13, wherein the input is the programmatic statement, wherein the programmatic statement conforms to a context-free grammar, and wherein generating the metadata representing the input comprises compiling the programmatic statement into a hierarchical structure of elements in the metadata.

16. The computer-implemented method of claim 13, wherein the input is the set of values, wherein the set of values were selected or entered into a menu-based interface, and wherein generating the metadata representing the input comprises transforming the set of values into a hierarchical structure of elements in the metadata.

17. The computer-implemented method of claim 13, wherein the input specifies the data source and transformations to be made to the data.

18. The computer-implemented method of claim 13, wherein the UI component definition includes static aspects and dynamic aspects, wherein the UI component definition specifies the static aspects and placeholders for the dynamic aspects, and wherein the data provides parameters for the placeholders.

19. The computer-implemented method of claim 13, wherein the platform UI builder displays an interface with a component selector section, a component display workspace section, and a component configuration section, wherein the component selector section displays the plurality of UI component definitions and allows selection of the UI component definition, wherein the component display workspace section displays a live representation of the custom UI component populated with the data, and wherein the component configuration section allows entry of the input.

20. An article of manufacture including a non-transitory computer-readable medium, having stored thereon program instructions that, upon execution by a computing system, cause the computing system to perform operations comprising:
receiving, by way of a platform UI builder, an input corresponding to selection of a UI component definition from a plurality of UI component definitions;
binding, according to a low-code module implemented as part of the UI builder, data specified as part of the input entered into the platform UI builder to the UI component definition, wherein the low-code module utilizes the data to populate the UI component definition, and wherein the data is from a data source, and wherein the input includes a programmatic statement that references the data source or a set of values that references the data source;
generating, by way of the platform UI builder, metadata representing the input and the populated UI component definition;
creating, by a platform runtime, a custom UI component according to the metadata including the data populating the UI component definition;
generating, by the platform runtime, a graphical user interface including the custom UI component; and
providing, for display on a client device, a representation of the graphical user interface.

21. The system of claim 1, wherein the low code module is a no code module implemented according to the received input.
